(19) United States
(12) Patent Application Publication
(10) Pub. No.: US 2010/0073120 A1
(43) Pub. Date: Mar. 25, 2010

(54) THERMAL FUSE FOR USE IN ELECTRIC MODULES

(75) Inventors: Norbert Knab, Appenweier (DE); Georg Schulze-Icking-Konert, Buehlertal (DE); Thomas Mohr, Buehlertal (DE); Stefan Kotthaus, Sinzheim (DE); Nikolas Haberl, Sinzheim (DE); Stefan Stampfer, Bietigheim-Bissingen (DE); Michael Mueller, Rutesheim (DE)

Correspondence Address: MERCHANT & GOULD PC, P.O. BOX 2903, MINNEAPOLIS, MN, 55402-0903, US

(73) Assignee: Robert Bosch GMBH, Stuttgart (DE)

(21) Appl. No.: 12/532,962

(22) PCT Filed: Jan. 28, 2008
(86) PCT No.: PCT/EP08/50930

§ 371 Date: Sep. 24, 2009

(30) Foreign Application Priority Data
Mar. 26, 2007 (DE) 10 2007 014 339.9

(51) Int. Cl. H01H 37/76

(52) U.S. Cl. 337/416

(57) ABSTRACT

The invention relates to a thermal fuse, especially for use in an electric module in the automotive field, comprising a connecting element (4, 25), which is electrically and mechanically connected to multiple connector points in order to provide a permanent and electrically conductive connection, and an actuator (6) which is configured separately from the connecting element (4, 25) and triggers without absorbing electrical energy when an ambient temperature reaches a trigger temperature, thereby mechanically interrupting the electrical connection formed by the connecting element (4, 25).

### STATE OF THE ART

The invention concerns thermal fuses for the use in electric modules in particular for applying high current.

In order to protect electric modules against overheating irreversible thermal fuses are required, which interrupt (trigger) a conductor that conducts current at a too high ambient temperature. The thermal fuses are thereby construed in such a way that the trigger temperature is not reached due to a current flow, so that it is ensured that they can be triggered only by a too high ambient temperature and not by a too high current. A thermal fuse serves also for providing an independent disconnecting path for electric modules, which safely disconnects the current flow at improperly high temperatures in the module, for example due to failure of components, short circuits, for example by external influences, malfunctioning of isolation material and such alike.

Usual thermal fuses are mostly based on a concept of a fixed spring, as for example a laminated spring that is soldered on. Thereby a mechanical force is exerted on the connecting element even in the not triggered case, which can cause quality issues in particular at longer operating times, as for example the long operating times in the automotive field. In particular a disruption of the solder connection can occur after a certain time.

It is therefore the task of the present invention to provide a thermal fuse, which safely interrupts a current flow and which provides a high reliability and long term stability. Furthermore it shall be ensured that the thermal fuse only triggers depending on the ambient temperature and not on the flowing current, so that also failures, which can only cause current flows, which are lower than the allowed maximum currents, can be safely detected.

This task is solved by the thermal fuse according to claim 1.

### DISCLOSURE OF THE INVENTION

According to one aspect a thermal fuse is provided, in particular for the use in an electrical module in the automotive field. The thermal fuse comprises a connecting element, which is electrically and mechanically connected to the connecting points, in order to provide a permanent and electrically conductive connection, as well as an actuator which is configured separately from the connecting element and triggers without absorbing electrical energy when an ambient temperature reaches a trigger temperature, thereby mechanically interrupting the electrical connection formed by the connecting element.

The thermal fuse has the advantage that the triggering of the thermal fuse is basically independent of the current that flows through the current flow through the connecting element due to the disconnected configuration of the connecting element and actuator but only depends on the ambient temperature of the thermal fuse. It is furthermore possible with the above configuration to arrange the connecting element without a preload between the connecting points, so that a danger of a degradation of the contacting of the connecting element at the connecting points can be reduced.

The actuator can furthermore be provided with a stamp, which can be moved in the direction of the connecting element in the case of a triggering in order to disconnect the electrical connected thereby.

According to an embodiment the actuator can be provided with a cutting mechanism in order to disconnect the connecting element at the triggering. The connecting element can thereby be configured as flat conductor, in particular as foil or plate. The flat conductor can in particular be provided with a predetermined separation point.

Furthermore the connecting points can be arranged on conducting areas of a punch grid. The actuator is thereby preferably arranged on a supporting element, which is mechanically connected to the punch grid, in order to determine an orientation of the actuator regarding the connecting element.

According to an embodiment the actuator comprises one or several materials, which react with each other and which are separated from each other by a fusible partition wall, whereby the melting temperature of the partition wall corresponds with the trigger temperature, whereby the actuator is arranged at the connecting element in such a way that a volume change due to the materials that react with each other interrupts the electrical connection that is created by the connecting element in the case of a triggering. The connecting element can furthermore be connected to the connecting points by a material that melts at a melting temperature, whereby the melting temperature of the fusible material is equal or lower than the triggering temperature.

The connecting element can furthermore be connected firmly with each of the connecting points or with the aid of a material that can melt at a melting temperature, whereby the melting temperature of the fusible material is equal to or lower than the triggering temperature.

According to an embodiment the stamp of the actuator is preloaded and held by a melting body, whereby the melting body is arranged in such a way that it melts and releases the preloaded stamp if the ambient temperature reaches the triggering temperature.

Further advantageous embodiments of the invention are stated in the dependant claims.

### DRAWINGS

Preferred embodiments of the invention are further explained in the following drawings. It is shown:

FIG. 1: a schematic cross section of a first embodiment of a thermal fuse;

FIG. 2 a schematic illustration of a cross section of a second embodiment of a thermal fuse;

FIG. 3 a cross section of an actuator for a thermal fuse according to the first or second embodiment;

FIGS. 4a to 4c schematic illustrations of a cross section of a thermal fuse according to a third embodiment before triggering, during triggering or after triggering.

### EMBODIMENTS OF THE INVENTION

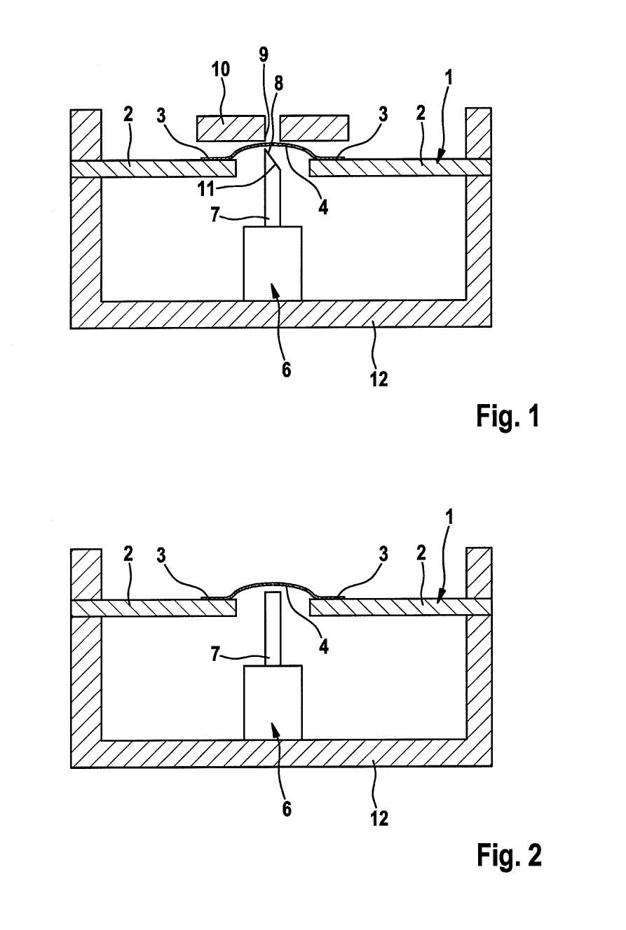

FIG. 1 shows a first embodiment of a thermal fuse schematically. The thermal fuse is located in a punch grid 1 between two conducting areas 2. The conducting areas 2 provide each a connecting point 3. The connecting points 3 are connected with each other by a flat conductor, as for example a current conducting foil 4 or a plate, for example made of Cu or another material, as connecting element, so that a current conducting connection exists between the conducting areas 2. At this embodiment the current conducting foil 4 is soldered to the connecting points 3 (punctured) and electrically and mechanically connected to the conducting areas 2 in a reliable way. The current conducting foil 4 can alternatively also be attached permanently at the connecting points 3 in a different way.

The punch grid 1 comprises a number of conducting paths and areas, which provide electrical connections between different positions in a module or to a module. The conducting paths of the punch grid can be embedded in an isolation material. At positions, at which the conducting paths should be contacted, the isolation material is removed and components or connections can be connected electrically with the conducting path of the punch grid 1.

Furthermore an actuator 6 is provided, which moves a stamp 7 in the direction of the current conducting foil 4, if an ambient temperature exceeds a triggering temperature. The stamp 7 provides an edge 8 at a free end, which skims along at a cutting edge 9 of a cutting element and thereby carries out a cutting. Between the cutting edge 9 and the edge 8 the current conducting foil 4 is located in a not triggered state of the thermal fuse.

If the stamp 7 is pushed upwards when triggering the thermal fuse by activating the actuator 6, the current conducting foil 4 is completely cut between the edge 8 and the cutting edge 9, in order to interrupt the current flow through the foil 4. The end of the stamp 7 that is pointed at the current conducting foil 4 provides an obliqueness 11, which pushes a part of the current conducting foil 4 away from a further part at the cutting position at a further movement of the stamp 7 along the cutting edge 9. The stamp 7 is preferably made of a non-conducting material, so that it can be definitely ensured after cutting through the current conducting foil 4 that no electric connection exists between the conducting areas 2 of the punch grip 1. Furthermore the material of the stamp 7 should be selected in such a way that the edge 8 keeps its sharpness over the entire lifetime of the thermal fuse, as for example ceramic.

The actuator 6 is preferably construed to move the stamp 7 without using electrical energy. Thus the triggering of the thermal fuse is not dependant on the provision of a current supply.

In order to define the position of the actuator 6 regarding the connecting element on the punch grid 1, the actuator 6 is arranged on a support element 12, which is connected to the punch grid 1 in a defined way. Thereby the orientation of the stamp 7 of the actuator 6 in the direction of the current conducting foil 4 can be ensured. The support element 12 is preferably thermo-conductive, for example made of a metal, in order to deliver the ambient heat to the actuator 6.

FIG. 2 shows a further embodiment of a thermal fuse schematically. The same reference signs indicate the same elements or elements with a similar function.

The thermal fuse of FIG. 2 comprises a punch grid 1 with two conducting areas 2, which are connected with each other by a current conducting foil 4 as connecting element. The current conducting foil 4 is soldered at a first conducting area 2 by a first connecting point 3 or electrically connected with the conducting area 2 differently in a permanent and reliable way. At a second connecting point 3 of a second conducting area 2 a further end of the current conducting foil 4 is also electrically connected. But the electrical contacting between the current conducting foil 4 and the second connecting point 3 is construed in such a way that the connection between the current conducting foil 4 and the second conducting area 2 is already dissolved due to an ambient temperature, if the actuator 6 triggers.

The actuator 6 provides no edge at this embodiment. The free end of the stamp 7 of the actuator 6 can be formed randomly. The stamp 7, which moves in the direction of the current conducting foil 4 in the case of a triggering, can lift the current conducting foil 4 in a simple way with a low exertion of force, so that the other end of the current conducting foil 4 disengages from the second connecting point 3 of the second conducting area 2 and thus interrupts the current flow. Preferably the stamp is also not conductive in the second embodiment; but it can also be conductive, because the interruption of the current flow takes place in the area of the second connecting point 3.

The electrically conductive connection between the second connecting point and the current conducting foil 4 can be created by a solder or with another conducting material. If the ambient temperature exceeds the melting temperature of the solder or the other conducting material the electrically conducting connection remains at first until the actuator 6 triggers at a further increase of the ambient temperature and the current conducting foil 4 can lift with a high exertion of force from the second connecting point 3 due to the melted state of the solder.

Alternatively both connecting points 3 can also be connected by soldering or another permanent connection with the current conducting foil 4. In that case the force that is exerted by the stamp 7 in the case of a triggering has to be so high to tear apart the current conducting foil 4 in order to interrupt the current flow. In order to simplify the tearing apart of the current conducting foil 4 the current conducting foil 4 can provide a narrowing, perforation or an area that has a reduced diameter at least in the area of the connecting point 3, in order to create a predetermined breaking point, if the actuator 6 triggers. Furthermore the current conducting foil 4 can be preloaded between the connecting points 3, so that a disconnecting is simplified, if the free end of the stamp 7 meets the current conducting foil 4.

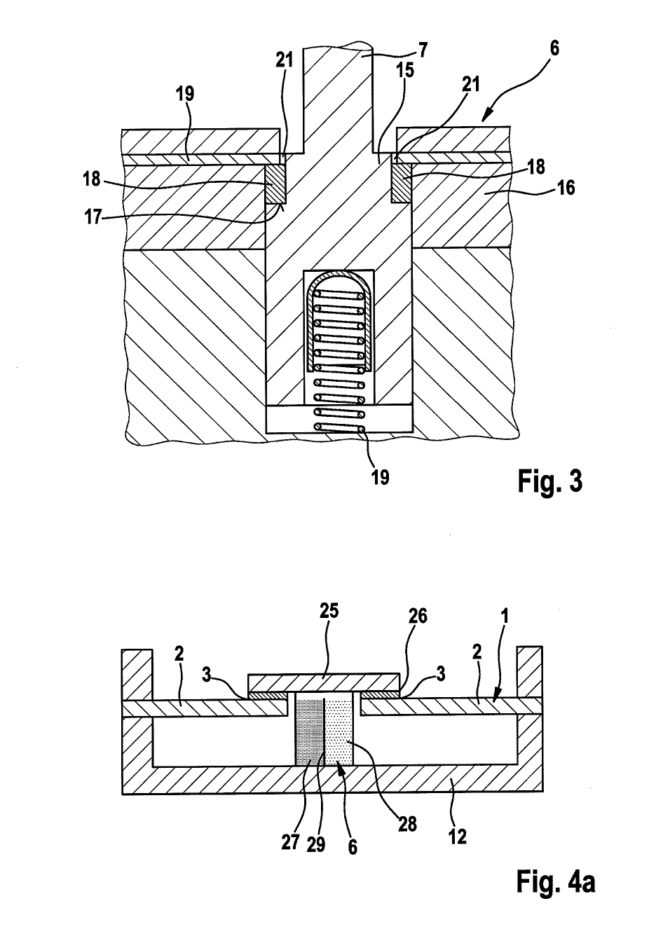

FIG. 3 shows an example for an actuator 6 in a cross-sectional view, as it can be used in the first and second embodiment. The actuator 6 comprises a cylindrical stamp 7, which is provided with a stop element 15, which is located on the inside of an actuator housing 16 of the actuator 6. The stop element 15 provides a preferably circumferential stop surface 17, which is kept distanced from a cover plate 19, which serves as a further stop surface 19 and through which the stamp 7 sticks out, by a fusible material 18 in the form of a melting body. The stop element 15 is preloaded over a spring 19, which is arranged between the actuator housing 16 and an inner surface of a recess in the stop element 15. The spring element 19 causes thereby a spring force of the stop surface 17 in the direction of the further cover plate 19, between which the fusible element 18 is arranged.

A triggering of this actuator 6 takes place if the temperature reaches or exceeds a melting temperature, at which the fusible material 18 melts and escapes from the actuator 6 through an opening 21 between the cover plate 19 and the stamp 7. The stop element 15 moves then with the stamp 7 towards the force of the spring element 19 and the stamp 7 is moved out of the actuator. Instead of such an actuator other actuators can also be provided, which trigger when exceeding a certain ambient temperature and carry out a movement of an element, which is used for disconnecting a current conducting connection, as for example a translational movement of the stamp 7, as it is shown in the embodiments of FIGS. 1 and 2.

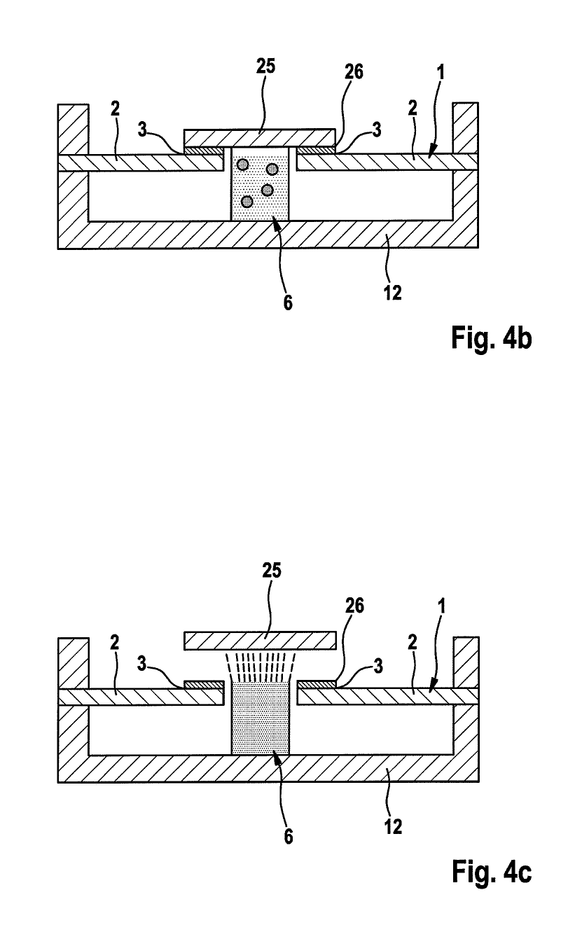

FIG. 4a shows a thermal fuse according to a third embodiment of the invention. A stiff connecting element 25 is set up between the connecting points 3 on the conducting areas 2 of the punch grid 1, which is conducting and electrically connected at the connecting points 3 over a conducting material 26 that melts at a certain temperature, as for example a solder. The melting point of the material 26 lies preferably below the triggering temperature of the actuator 6. The actuator 6 is for example created as detonating cap, in which for example two materials 27, 28 that react with each other can be separated from each other by a fusible partition wall 29. Alternatively pellets can also be provided, which contain one of the materials and which provide a coating made of the fusible material of the partition wall. When exceeding the triggering temperature the coating melts and the two materials that react with other come into contact.

According to another alternative an ignitable material can be provided, which ignites at a corresponding triggering temperature, whereby an exothermal reaction takes place, which causes a corresponding volume change. Preferably the igniting material is selected in such a way that it reacts in an exothermal reaction, which catalyzes itself.

As it is shown in FIG. 4b the partition wall 29 melts as soon as the triggering temperature is reached or exceeded, and causes that the two materials 27, 28 that react with each other come into contact and react. The reaction causes a volume expanding in the direction of the connecting element 25, which is then lifted or displaced from the connecting points 3, on which the already melted material 26 is located, and thereby interrupting the conducting connection between the conducting areas 2, as it is illustrated in FIG. 4c, which shows the case of a triggering.

Further embodiments are possible, which use a bimetal actuator as actuator or a memory metal actuator as triggering element.

An actuator can also provide a preloaded spring element, which is held under preload by a melting element. When reaching the triggering temperature the melting element melts and the spring element softens and interrupts the foil 4 or generally the flat conductor.

It has to be made sure in all embodiments, that the corresponding actuator contains no flammable materials.

The connecting element 4, 25 is construed in all embodiments in such a way that no considerable temperature increase of the connecting element occurs at maximum current, for which the thermal fuse is configured, which means the electrical resistance or the cross section is selected in such a way that the maximum current can be carried well through the connecting element. A triggering of the thermal fuse should only take place mechanically by activating the actuator and be irreversible, which means the opened fuse cannot become conductive again under any circumstances.

1-10. (canceled)

11. A thermal fuse for use in an electric module in an automotive field, comprising:
a connecting element connected electrically and mechanically to several connecting points to provide a stable electrically conductive connection; and
an actuator arranged separately from the connecting element and that triggers without absorbing electrical energy if an ambient temperature reaches a triggering temperature and mechanically interrupts the electrical connection created by the connecting element.

12. The thermal fuse of claim 11, wherein the actuator comprises a stamp that is actuated in direction of the connecting element upon triggering.

13. The thermal fuse of claim 11, wherein the actuator comprises a cutting mechanism to disconnect the connecting element upon triggering.

14. The thermal fuse of claim 11, wherein the connecting element is arranged as a current conducting flat conductor.

15. The thermal fuse of claim 14, wherein the flat conductor comprises a predetermined separation point.

16. The thermal fuse of claim 11, wherein the connecting points are arranged on conductor areas of a punch grid.

17. The thermal fuse of claim 16, wherein the actuator is arranged on a support element that is connected to the punch grid to determine an orientation of the actuator regarding the connecting element.

18. The thermal fuse of claim 11, wherein the actuator comprises one or several materials that react with each other and are separated from each other by a fusible partition wall, wherein a melting temperature of the partition wall corresponds with the triggering temperature, and wherein the actuator is arranged at the connecting element such that a volume change due to the materials reacting with each other interrupts the electrical connection created by the connecting element upon triggering.

19. The thermal fuse of claim 18, wherein the connecting element is connected to the connecting points by a material that melts at a melting temperature, wherein the melting temperature of the fusible material is equal to or less than the triggering temperature.

20. The thermal fuse of claim 11, wherein the connecting element is one of firmly connected to each of the connecting points and connected with a material that melts at a melting temperature, wherein the melting temperature of the fusible material is equal to or less than the triggering temperature.
